(19) United States
(12) Patent Application Publication
(10) Pub. No.: US 2004/0168854 A1
(43) Pub. Date: Sep. 2, 2004

(54) Scaffold

(76) Inventor: Shlomo Azran, Kiryat-Gat (IL)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/479,151

(22) PCT Filed: May 31, 2001
(86) PCT No.: PCT/IL01/00505

(51) Int. Cl. E04G 1/18

(52) U.S. Cl. 182/141

(57) ABSTRACT

Scaffold erected adjacent to a wall, which enables an easy plastering, drying cleaning, coloring, etc. operation of the wall by automatic means. Said scaffold comprises: a. a platform being erected adjacent and parallel to the wall; b. column members carrying the platform and being connected to the wall, said columns being provided with electrically actuating means enabling the ascending and descending of the platform: c. a movable apparatus (or “cat”) being attached to the platform, preferably located thereunder, which cat is able to move along the length of the platform and is provided with automatic means for actuating the plastering operation and realizing obstacles: d. automatic means for actuating the movable parts of the scaffold; and e. a storage container being suitably connected to the means performing the plastering operation.

The present invention relates to a scaffold erected adjacent to a wall (hereinafter called “scaffold”), which scaffold enables an easy plastering, drying cleaning, coloring, etc. operation (hereinafter called “plastering”) of the wall by automatic means. It also enables an easy performance of repair and the like operations as well as manual performances, if required.

There are known many scaffolds for this purpose erected adjacent to a wall, e.g. that described and claimed in patent specification No 113,940. However, these known structures are quite complicated in their use, in particular as that use requires much manpower in the course of the plastering operation. Moreover, in none of said known scaffolds the plastering operation can be performed automatically without manual work, e.g. with electrical means and by remote control.

It has thus been desirable to design a scaffold to be erected adjacent to a wall which enables a simple automatic performance of the plastering, inter alia, with rather non complicated electrical means, e.g. by way of remote control. The costs involved in the production of said scaffold should be reasonable and it production and erection should not be complicated.

The present invention thus consists in a scaffold (as herein defined) comprising:

a. a platform being erected adjacent and parallel to the wall;

b. column members carrying the platform and being connected to the wall, said columns being provided with electrically actuating means enabling the ascending and descending of the platform;

c. a movable apparatus (herein called “cat”) being attached to the platform, preferably located thereunder, which cat is able to move along the length of the platform and is provided with automatic means for actuating the plastering operation and realizing obstacles;

d. actuating electrical pneumatic and/or electrical hydraulic means for actuating the various movable parts of the scaffold; and

e. a storage container being suitably connected to the means performing the plastering operation.

The actuating electrical means are advantageously actuated by remote control means.

The platform advantageously comprises the following parts:

a. floor on which is located a basis;

b. two railings extending vertically along the two sides of the floor;

c. at least one bar of tooth wheels extending along the side of the floor and being provided with means carrying the cat and causing the movement thereof;

d. supports for guiding electrical motors; and

e. openings for the columns.

In an advantageous embodiment there extend two bars of tooth wheels along both sides of the floor.

On the platform is preferably located a compressor on which is mounted a board to which are connected a radio receiver and a control panel. Said compressor actuates the movement of the cat.

There has to be present one central column and at least one side column.

Each column comprises an outside sheet. Said sheet is connected at both sides to a further sheet via a comb-like wall in such a manner that the sheets form a cavity between them.

The further sheet is advantageously provided with several openings.

In said columns is located at least one system (advantageously more), which prevents the descent of the entire platform. Said system may be, e.g. cables inserted in the comb like wall.

Outside of the columns extend preferably suitable cables being connected to rotating drums on which they are rolled. The drums and thus the cables are actuated by electrical means, e.g. motors and gears at least at the central column, which may be actuated by remote control means, which motors cause the ascending and descending of the platform.

The manner in which the cables are located on the drums determines the required height of the platform. The central column is advantageously connected to two drums each being actuated by a motor and a gear, both motors and gears suitably operating in a synchronized manner.

The cat enables the plastering means to move automatically along the length of the platform. Thus, the plastering can be performed in a convenient manner along the entire length of the wall in the desired height and at the desired location.

The cat is preferably provided with an electrical eye, sensors and/or a camera. Said means indicate places where the cat cannot move as a result of an obstacle caused by a rod, a window, a place which is not properly plastered or the like. The eye actuates means, e.g. openings of rails extending on the platform so that the cat may then continue to move on.

The storage container comprises the suitable plastering, drying, cleaning, coloring, etc. material required for the operation to be performed. Care should be taken that a always enough material is present in the container. The plastering material is forwarded advantageously from the container to the plastering means by an electrically actuated pump, cables etc.

The scaffold according to the present invention may be actuated entirely in an automatic manner. The plastering operation thus does not require any manpower on the platform. The height of the platform, the location of the plastering arrangement and the movement thereof can be controlled by way of a remote control apparatus. The performance of the plastering operation can also be actuated by the same remote control apparatus.

The electrical actuation of the various electrical elements may be performed in any conventional manner by suitable electrical elements, e.g. a motor, a gear etc.

The present invention will now be illustrated with reference to the accompanying drawings without being limited by them. (Identical parts appearing in several Figs will be referenced for the sake of clarity by the same numerals.)

In said drawings:

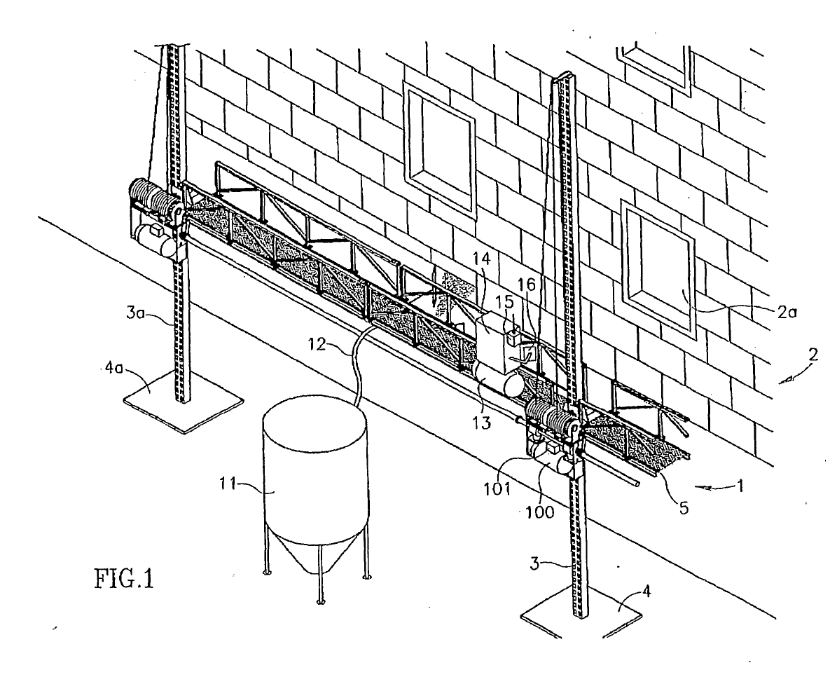

FIG. 1 shows a general perspective view of a scaffold according to the present invention being connected to a wall;

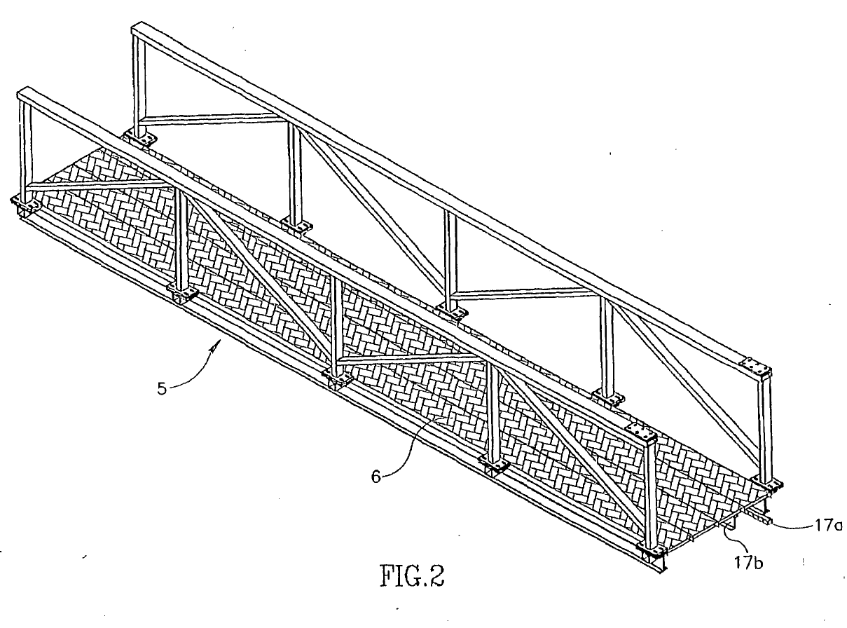

FIG. 2 shows an enlarged view of a platform;

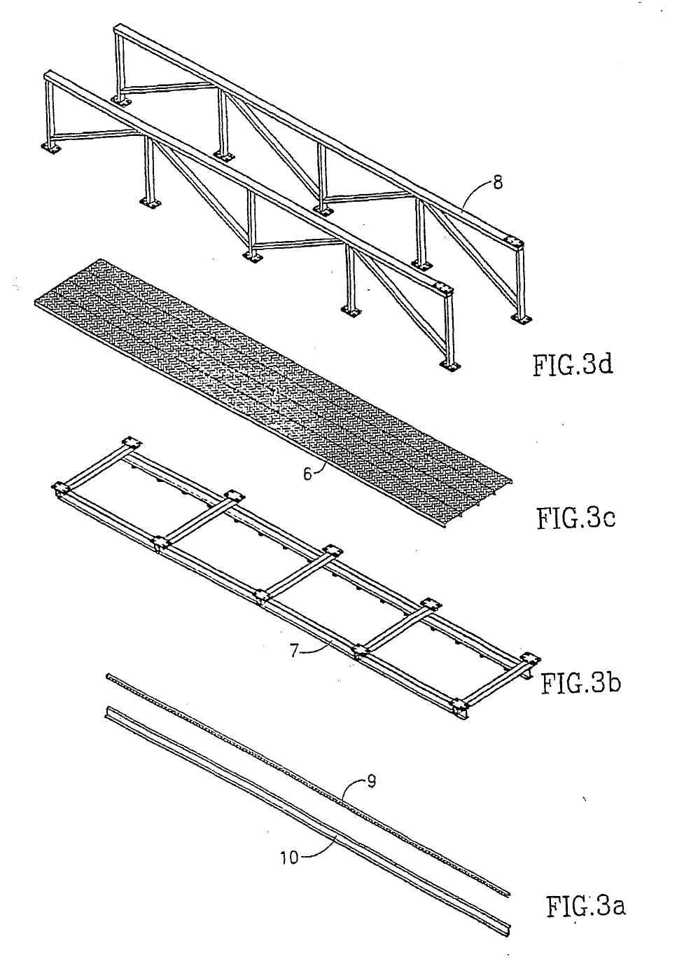

FIGS. 3a-d show the parts of the platform;

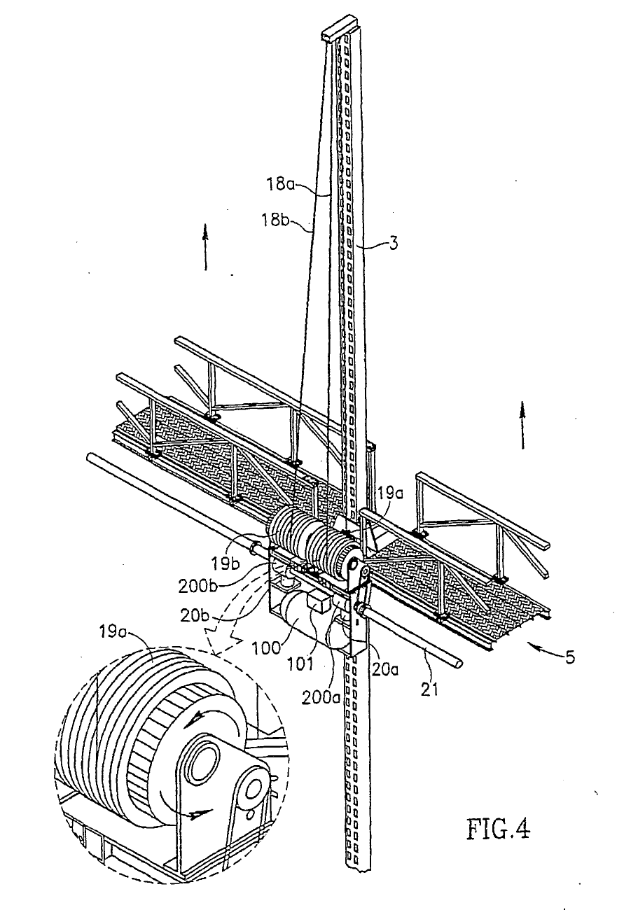

FIG. 4 shows a enlarged general perspective view of a platform through which passes a central column;

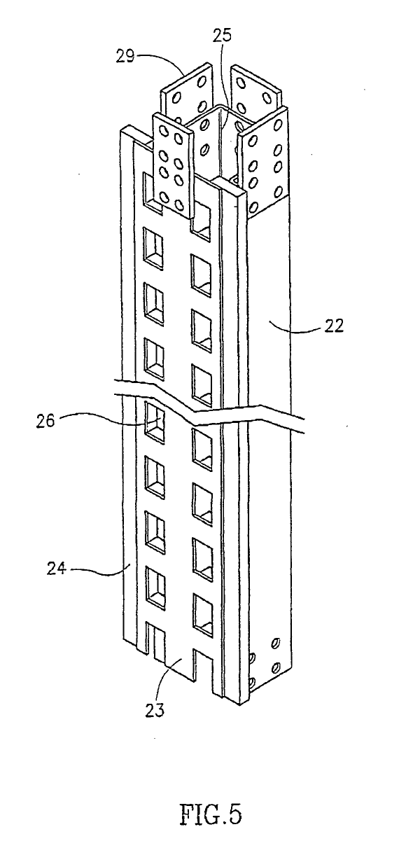

FIG. 5 shows an enlarged view of column;

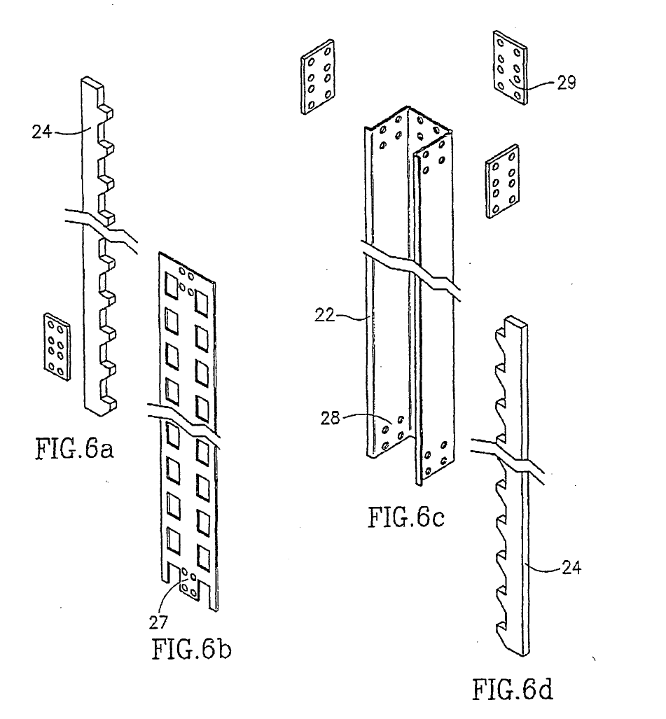

FIGS. 6a-d show the parts of the column;

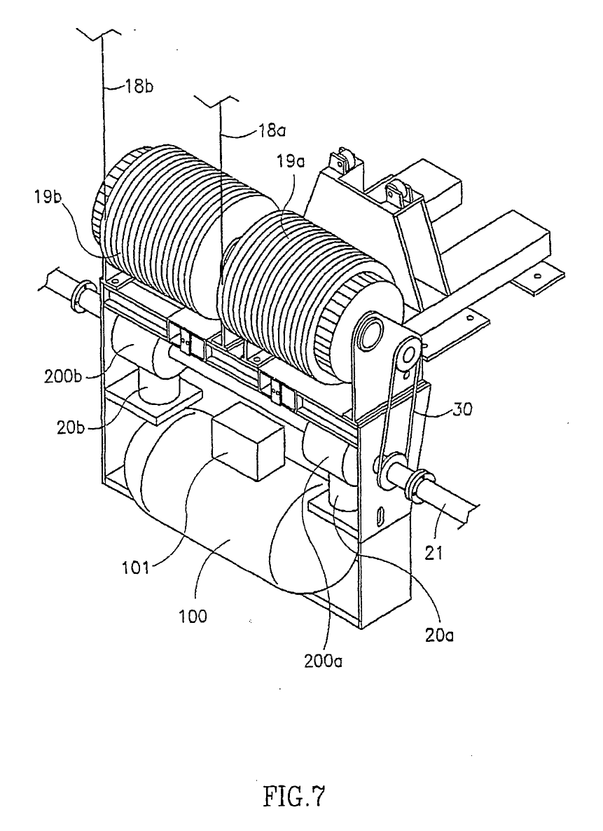

FIG. 7 shows an enlarged view of the system causing the ascent and descent of the platform.

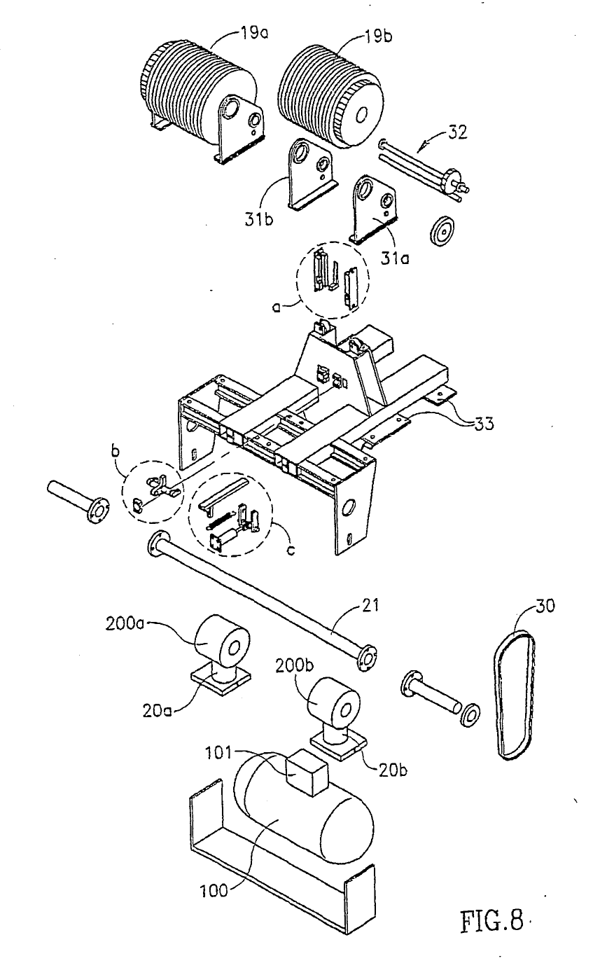

FIG. 8 shows parts of the system shown in FIG. 7 causing ascending and descending of the platform;

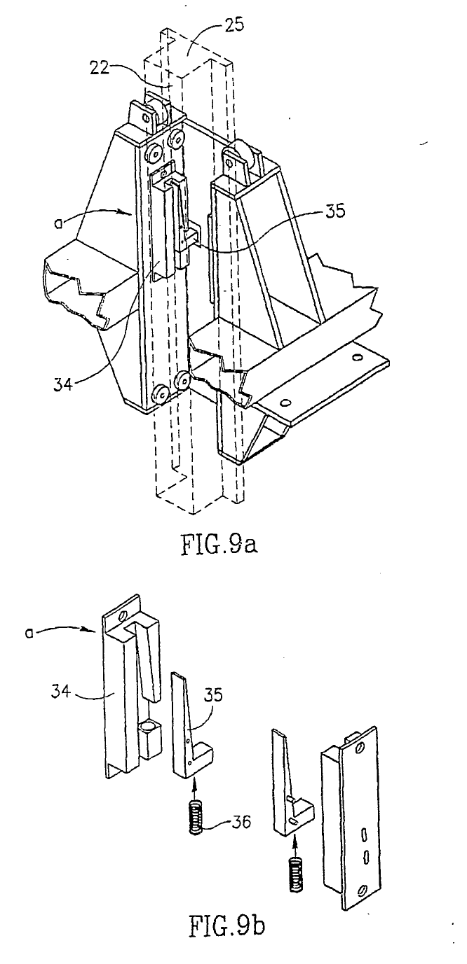

FIGS. 9a and 9b show system a preventing descent of the platform;

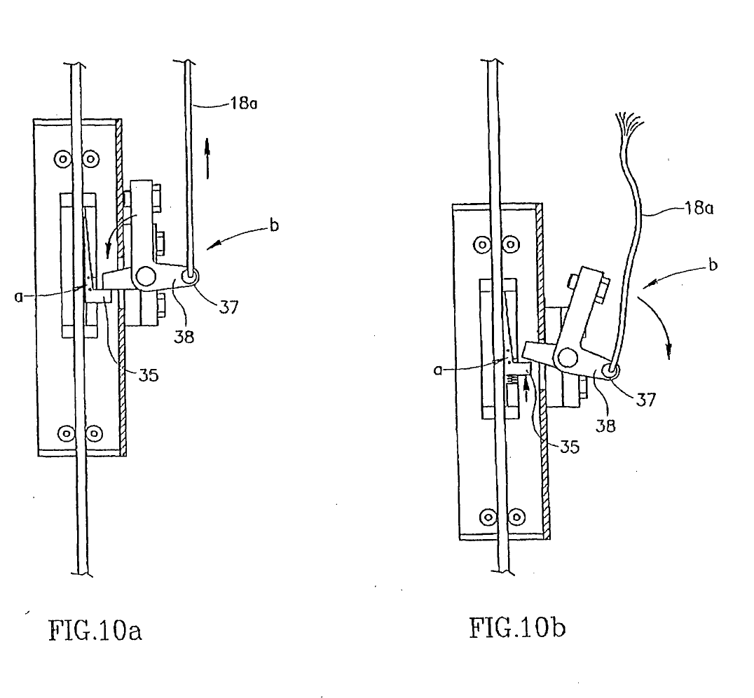

FIGS. 10a and 10b show system b preventing descent of the platform;

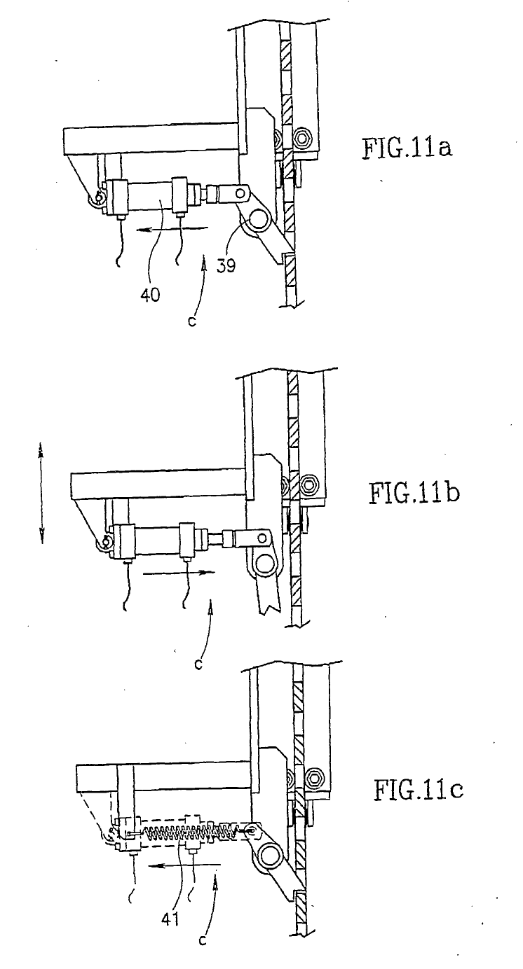

FIGS. 11a, 11b and 11c show system c preventing the descent of the platform;

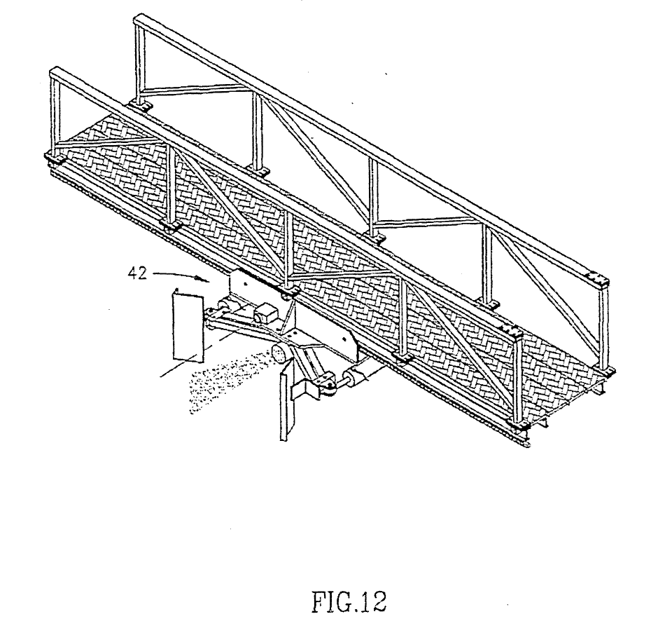

FIG. 12 shows a platform provided with a cat;

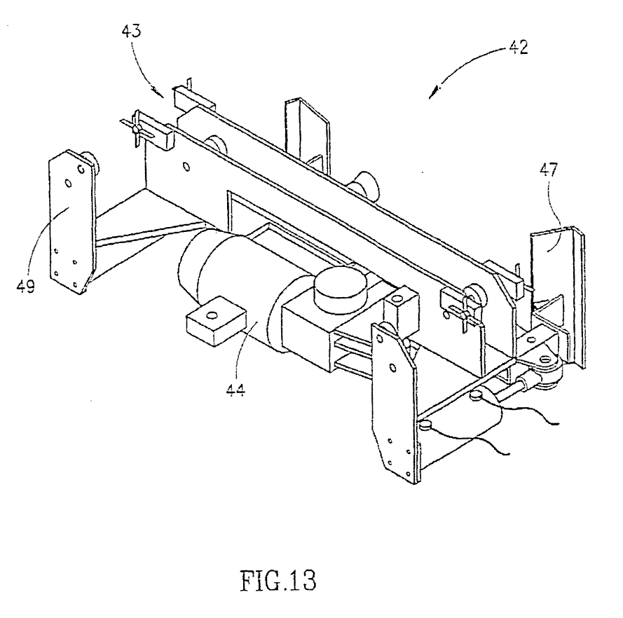

FIG. 13 shows an enlarged perspective view of a cat;

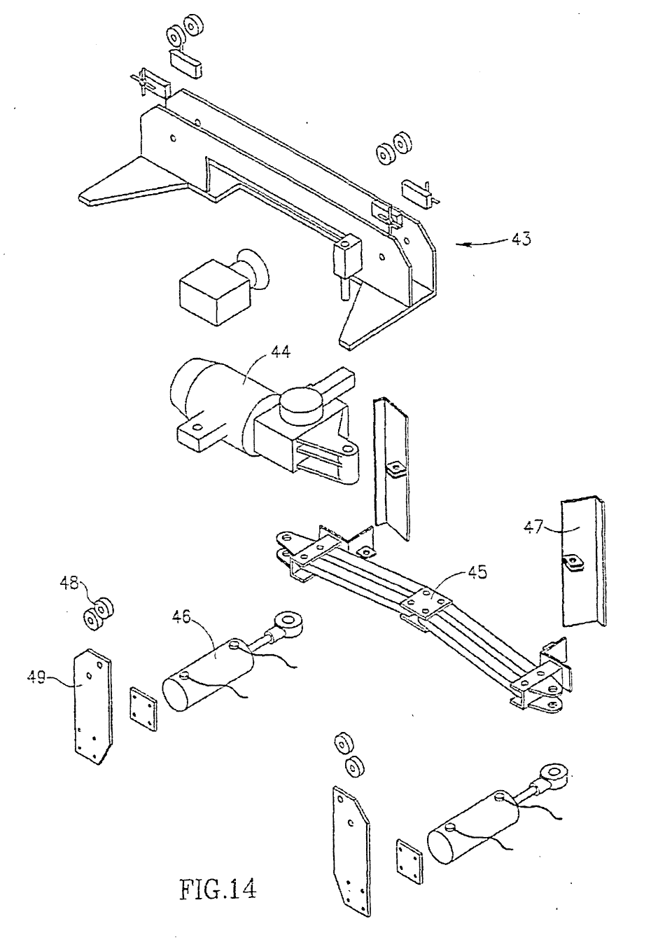

FIG. 14 shows parts of the cat shown in FIG. 13;

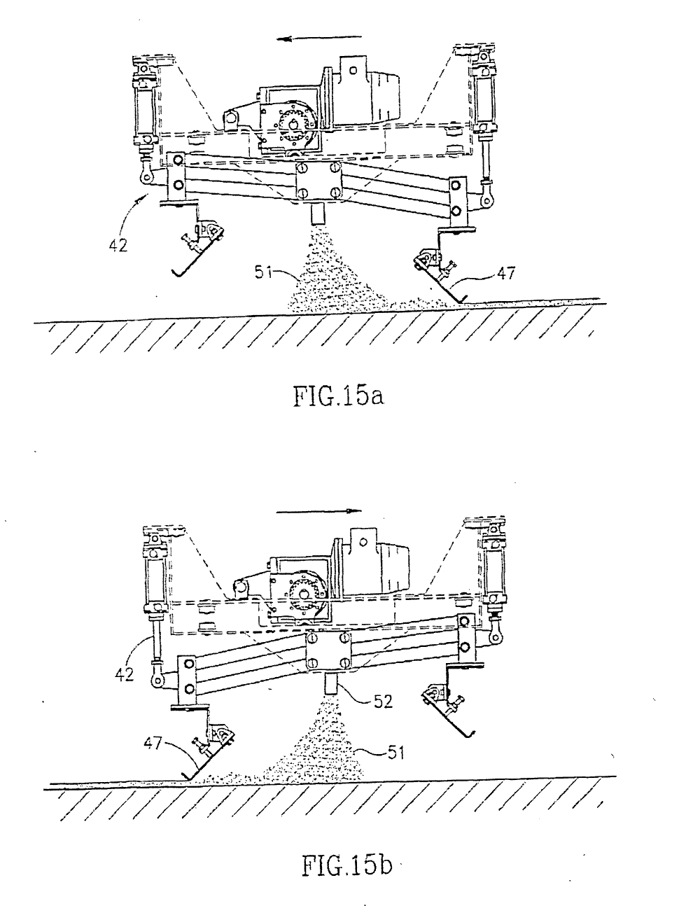

FIGS. 15a and 15b show the movement of the cat shown in FIGS. 13 and 14;

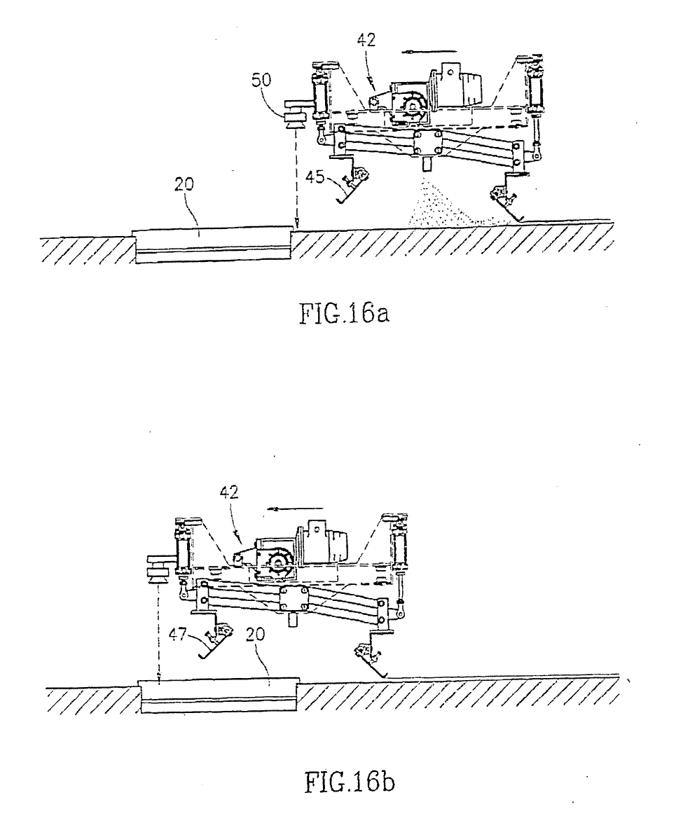

FIGS. 16a and 16b show the movement of the cat shown in FIGS. 13 and 14 on a platform which has obstacles for said movement;

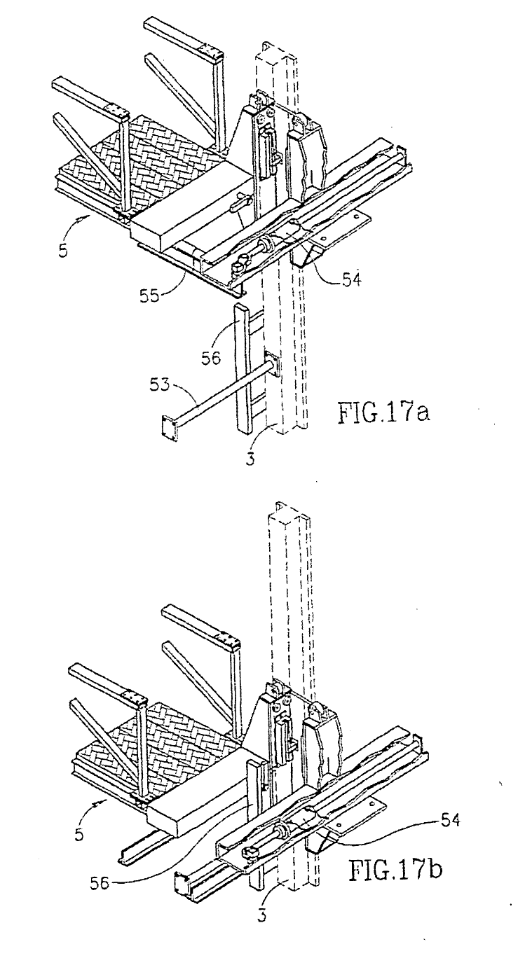

FIGS. 17a and 17b show the movement of the platform where a rod is connecting the column to the wall; and

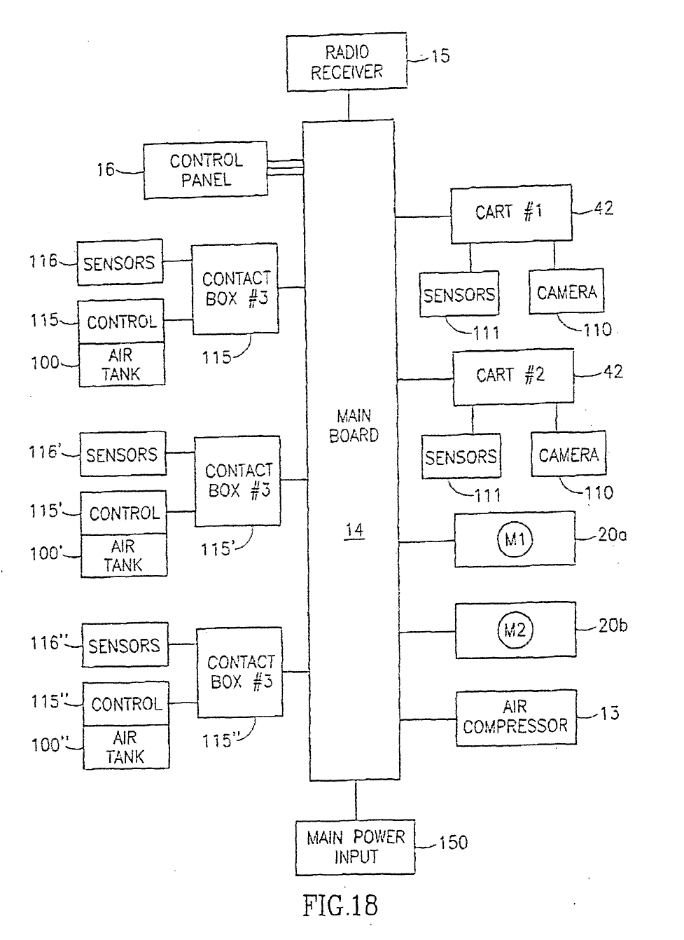

FIG. 18 shows a block diagram of a flow sheet whenever three columns and two cats are present.

Scaffold 1 shown in FIG. 1 is connected to wall 2 which is provided with window 2a. Wall 2 is connected by means (not shown) to central column 3 and to side column 3a standing on basis 4 and 4a, respectively. The columns will be described in detail in FIGS. 4 to 6.

Storage container 11 is connected by cable 12 to the plastering means (not shown).

Upon platform 5 is located compressor 13 actuating all hydraulic parts. On compressor 13 is arranged main board 14 being connected to radio receiver 15 and control panel 16. Radio receiver 15 and control panel 16 actuate compressor 13 via main board 14. Also shown are air tank 100 and control 101. Air tank 100 is an air reservoir which aids compressor 13 to actuate the various hydraulic parts.

Platform 5 of scaffold 1 shown in FIGS. 2 and 3 comprises floor 6 on which is located basis 7 (shown only in FIG. 3b), railings 8, bar 9 of tooth wheels (shown only in FIG. 3a) and support line for carrying the cat (not shown). Guiding support 10 extends parallel to floor 6 of platform 5.

Platform 5 is provided with openings (not shown) through which columns 3 and 3a can pass.

Platform 5 is shown in detail in FIGS. 2 and 3a-d. The platform shown in FIG. 2 shows also wheels 17a and 17b. Said wheels 17a and 17b carry the cat (not shown).

In FIG. 4 is shown column 3 passing through an opening (not shown) of platform 5.

Column 3 is described in detail in FIGS. 5 and 6. Outside column 3 extend cables 18a and 18b being rolled on drums 19a and 19b respectively. Drums 19a and 19b are actuated by motors 20a and 20b located via gears 200a and 200b respectively on dry shaft 21 which dry shaft 21 actuates further drums (not shown). (An enlarged embodiment of drum 19a and the movement thereof is shown at the bottom of FIG. 4.)

The column shown in FIGS. 5 and 6 comprises outside sheet 22. Sheet 22 is connected at both sides to sheet 23 via comb-like wall 24 in such a manner that said sheets form cavity 25 between them.

The various parts of the column are shown in detail in FIGS. 6a-e.

Wall 23 is provided with openings 26 and at the bottom and at the top thereof with holes 27. Holes 28 are located at the bottom and the top of outside sheet 22. Further are shown parts 29.

Comb-like wall 24 avoids armour-mooring strength of the internal parts thereof.

FIGS. 7 and 8 show the operating system in which are shown drums 19a and 19b on which are rolled cables 18a and 18b, respectively. Said drums 19a and 19b are caused to rotate by motors 20a and 20b, gears 200a and 200b and by band-like wheels 30. Motors 20a and 20b are located via gears 200a and 200b respectively on dry shaft 21.

FIG. 8 shows in detail the separate parts of the system shown in FIG. 7. Said parts are drums 19a and 19b on which are rolled cables 18a and 18b, respectively (not shown). Outside of the drums are located walls 31a and 31b through which pass rods 32 actuating drums 19a and 19b.

Motors 20a and 20b, gears 200a and 200b, band wheel 30 and dry shaft 21 are shown separately.

Moreover, there is shown support 33 for platform 5 (not shown).

Systems a, b and c which prevent the undesired descend of platform 5 are shown in detail in FIGS. 9, 10 and 11.

In FIG. 9a there is shown at both sides of hole 25 attaching both side wall 22 of column 3 system a which prevents said undesired descend of platform 5.

In FIG. 9b there is shown in detail system a attached to wall 22. Said system a comprising housing 34 in which triangle 35 is located on springable means 36, which springable means 36 prevent by friction the descend of platform 5 when cable 18 (not shown) is torn.

FIGS. 10a and 10b show system b preventing the descend of platform 5 which co-operate with system a shown in FIGS. 9a and 9b.

Said system b comprises the following parts and operates as follows;

In FIG. 10a cable 18a in the ascending position is caught in hole 37 of part 38. Part 38 is located on the basis of triangle 35. When cable 18a is torn as shown in FIG. 10b, system a ascends upwards and stops the descending movement.

System c preventing the descend platform 5 shown in FIGS. 11a-c comprise the following parts:

Arm 39 is connected at one end to piston 40 and at the other end to the openings of comb 24. As is shown in FIG. 11c piston 40 extends parallel to springable means 41.

FIG. 11a shows a regular ascending position.

FIG. 11b shows the open descending position. Whenever something happens, as shown in FIG. 11c, spring means 41 pushes arm 39 into the openings of comb 24.

Platform 5 shown in FIG. 12 is the same platform 5 shown in FIG. 2 (drawn in the opposite direction) comprising cat 42, being located below floor 6.

An enlarged perspective view of cat 42 is shown in FIGS. 13 and 14. An undisturbed movement of cat 42 along platform 5 is shown in FIGS. 15a and 15b and the movement of cat 42 on platform 5 which has obstacles is shown in FIGS. 16a and 16b.

Cat 42 shown in FIGS. 13-15 comprises basis 43 to which is connected device 44 causing cat 42 to move horizontally. Unit 45 is connected to basis 43.

As is shown unit 45 is connected at both ends to cylinder 46 actuating plastering means 47. There are also shown various sheets 48 and connecting parts 49.

An undisturbed movement of cat 42 is shown in detail in FIGS. 15a and 15b. In FIG. 15a the movement is from right to left whereas in FIG. 15b the movement is in the opposite direction.

Cat 42 shown in FIGS. 16a and 16b comprises optical eye 50 connected to cat 42. Said eye 50 regulates the plastering operation and stops it when necessary, e.g. at window 20.

FIGS. 15 and 16 show plastering material 51 which passes through opening 52.

In FIGS. 17a and 17b is shown platform 5 through which passes column 3. Column 3 is provided with rods 53 (only one shown) being connected to wall 2. Internal piston 54 causes the opening of rail like 55 and thus allows the descending and ascending of platform 5 inspite of rod 53. Also is shown structure 56 which is connected to column 3.

The electric block diagram comprising the parts actuating the mechanical parts illustrated in FIGS. 1 to 17 is shown in FIG. 18.

Radio receiver 15 receives the instructions from the remote control (not shown) and is in turn connected to main board 14.

Main board 14 receives electricity from main power input 150.

Instructions are being sent from the remote control via receiver 15 and main board 14 to cats 42 and 42′. Said cats 42 and 42′ are connected to cameras 110 and 110′. Said cameras 110 and 110′ together with sensors 111 and 111′ controls wall 2 in order to reveal obstacles, to control the quality and the distribution of the plaster, the color, the coating, etc.

Main board 14 actuates also motors 20a and 20b, which cause the ascending and descending of platform 5 on columns 3. It also actuates the operation of compressor 13.

Main board 14 also actuates control panel 16 for manual operation.

Main board 14 actuates various contact boxes 115, 115′ and 115″ which are located besides column 3. Said control box 115, 115′ and 115″ via sensors 116, 116′ and 116″ indicate the position of column 3 and of platform 5. whether there are obstacles on wall 2, etc.

Air tanks 100, 100′ and 100″ actuate via control boxes 115, 115′ and 115″ the various pistons (not shown).

As the other parts above, also air compressor 13 is operated by main board 14.

1. A scaffold (as herein defined) comprising:
a. a platform being erected adjacent and parallel to the wall;
b. column members carrying the platform and being connected to the wall, said columns being provided with electrically actuating means enabling the ascending and descending of the platform;
c. a movable apparatus (herein called “cat”) being attached to the platform, preferably located thereunder, which cat is able to move along the length of the platform and is provided with automatic means for actuating the plastering operation and realizing obstacles;
d. automatic electrical pneumatic and/or electric hydraulic means for actuating the movable parts of the scaffold; and
e. a storage container being suitably connected to the means performing the plastering operation.

2. A scaffold in which the automatic electrical means are actuated by remote control means.

3. A scaffold according to claim 1 or 2, in which the platform comprises the following parts:
a. floor on which is located a basis;
b. two railings extending vertically along the two sides of the floor;
c. at least one bar of tooth wheels extending along the side of the floor and being provided with means carrying the cat and causing the movement thereof;
d. supports for guiding electrical motors; and
e. openings for the columns.

4. A scaffold according to claim 3, in which extend two bars of tooth wheels extending along both sides of the floor.

5. A scaffold according to claims 3 or 4, in which on the platform is located a compressor on which is mounted a board to which are connected a radio receiver and a control panel.

6. A scaffold according to any of claims 1 to 5, comprising one central column and at least one side column.

7. A scaffold according to any of claims 1 to 6 in that each column comprises an outside sheet; such sheet being connected at both sides to a further sheet via a comb-like wall in such a manner that the sheets form a cavity between them; the further sheet being provided with several openings.

8. A scaffold according to claim 7 in which in the column is located at least one system, which prevents the descent of the entire platform.

9. A scaffold according to any of claims 6 to 8, in which outside of the columns extend suitable cables being connected to rotating drums on which they are rolled, the drums and the cables being actuated by motors.

10. A scaffold according to any of claims 6 to 9 in which the central column is advantageously connected to two drums each being actuated by a motor, both motors operating in a synchronized manner.

11. A scaffold according to any of claims 1 to 10, in which the cat is provided with an electrical eye, sensors and/or a camera.

12. A scaffold according to any of claims 1 to 11 in which the plastering material is forwarded from the container to the plastering means by an electrically actuated pump.

13. A scaffold according to any of claims 1 to 12, in which the cat is attached below the platform.

14. A scaffold according to any of claims 1 to 13, in which the scaffold is constructed in such a manner that it operates in an entirely automatic manner.

15. A scaffold as defined in claim 1, substantially as herein described with reference to the accompanying drawing.
